(19) United States
(12) Patent Application Publication
(10) Pub. No.: US 2009/0236380 A1
(43) Pub. Date: Sep. 24, 2009

(54) INFANT CARRIER COMPONENT FOR EMERGENCY EVACUATION SLED

(76) Inventor: Clifford G. Adkins, Des Peres, MO (US)

Correspondence Address: SENNIGER POWERS LLP, 100 NORTH BROADWAY, 17TH FLOOR, ST LOUIS, MO, 63102, US

(21) Appl. No.: 12/052,746

(22) Filed: Mar. 21, 2008

(51) Int. Cl. A61G 1/00

(52) U.S. Cl. 224/161

(57) ABSTRACT

A lightweight “adaptor” or “insert” is disclosed, which will enable a non-powered transport device (such as a lightweight collapsible sled) to safely and securely transport several infants at once. The insert can be quickly but securely strapped to the sled, and three or more infants can be strapped down in accommodating basins (or pockets, wells, trays, or similar terms) on the upper surface of the insert. It will provide cushioning as well as thermal insulation, and can provide bedding for several infants if a need arises, for as long as the need persists. One or more “pockets” (or wells, basins, etc.) can be provided in the insert, to carry and hold various types of equipment, such as medical supplies, pharmaceuticals, special nutrients, or equipment that may be needed by one or more of the infants being held by the carrier device.

### BACKGROUND OF THE INVENTION

This invention is in the field of mechanical and molded plastic devices, and relates to a convenient and lightweight sled for use in transporting people in emergency situations.

Background information on this invention is provided in U.S. utility patent application Ser. No. 11/123,568, filed in May 2005, entitled, “Lightweight Plastic Sleds for Emergency Transport and Hauling of Loads”. Briefly, that application discloses a specialized type of lightweight plastic sled, made from a single layer of thin and flexible but tough and strong plastic, which can be rolled up for storage, when not in use, into a cylinder that has roughly the same diameter as a roll of paper towels.

In one embodiment that is suited for dragging a “dead load”, such as a load of firewood, a deer carcass, etc., a rope, strap, or other tension-bearing member is passed through a hole near the front of the sled, and the rope or strap is wrapped around and tied to (or otherwise secured directly to) the load that will be dragged or hauled. This enables the sled, in an unrolled configuration, to provide a smooth slidable surface beneath a heavy load that is being dragged across rough and uneven terrain, without subjecting the sled itself to the types of tensile stresses that would tear the plastic material.

In an alternate embodiment that is suited for carrying a live person, a relatively wide strap or belt that is made of nylon or similar material can be threaded, in alternating upward and downward directions, through a series of slots that are spaced around the periphery of the sled. This will allow the segments of strap which are positioned on the upper side of the sled to be gripped, by hand, by people on opposing sides of the sled, thereby allowing the sled to be used to lift and carry a person.

Alternately, if only one “helper” is available to drag a sick or injured person from one location to another, then one end of a strap or rope can be securely tied or otherwise affixed to a belt, harness, backpack, or other device that is being carried by the “helper, while the other end of the strap or rope can be tied to the strap that is laced through the slots around the periphery of the sled. This will enable the “helper” to exert a strong pulling force (mainly using his legs rather than arms) on the sled. Since that strong pulling force will be effectively distributed around the entire periphery of the sled, by means of the strap that is laced through the slots around the periphery of the sled, then that pulling force will not pose a major threat of tearing the sled.

Since both of those two transport options are provided by a single type of sled that is small enough and light enough to be carried anywhere on foot (such as out on a military patrol, deep into a forest, etc.), that also can be stored conveniently in a small volume, these new and innovative sleds have become popular and commercially successful, for purchase and use by hospitals, nursing homes, and other facilities that may need to rapidly evacuate people who cannot walk under their own power, if a major emergency occurs. These sleds are sold by ARC Products, under the trademark “MedSleds”, as shown at www.medsled.com. As mentioned above, more information on these sleds is available in patent application Ser. No. 11/123,568, coinvented by Adkins, the same inventor herein.

This current application discloses an additional optional component that is designed and adapted for use with those types of lightweight sleds. Briefly, this type of additional component is designed to be secured to a single sled, to convert the sled (which is large enough to carry a grown adult) into a means for carrying several “infants”. That term is used herein to include newborn babies, infants who cannot yet walk, and very small children who may not be able to walk under their own power for various reasons. There is no specific age limitation that applies herein to the term “infants”; instead, the term is used to refer to any baby, infant, toddler, or child that is small enough to be carried effectively in an infant carrier as described herein. These transport devices are designed mainly for the type of “standby preparedness” that can enable hospitals, orphanages, other types of facilities to be ready to deal with emergencies. Since many such facilities must care for babies and children with developmental problems, including problems that can reduce or retard growth rates, size rather than age is the crucial factor that will determine whether a small child can be safely and securely transported by a carrier device as described herein.

Accordingly, one object of this invention is to provide a device and means to adapt a single lightweight sled, large enough to carry a grown adult, so that it can safely and securely transport several infants at once.

Another object of this invention is to provide an inexpensive and lightweight “adaptor”-type device or insert, which can enable a lightweight collapsible sled to safely and securely transport both (i) several infants, and (ii) any equipment or specialized medicine or supplies that such infants might need, simultaneously.

Another object of this invention is to provide an inexpensive and lightweight “adaptor”-type device or insert, designed primarily to enable the safe and secure transport of several infants, that also can provide comfortable and thermally-insulated sleeping accommodations for such infants, in case a need arises for such accommodations.

These and other objects of the invention will become more apparent through the following summary, drawings, and detailed description.

### SUMMARY OF THE INVENTION

An inexpensive and lightweight “adaptor” or “insert” device is disclosed, which will enable a lightweight collapsible sled to safely and securely transport several infants at once, along with any essential equipment and/or supplies. This device fits into a lightweight sled, large enough to carry an adult and made of a sheet of tough but flexible plastic that can be rolled into a cylinder for storage. The insert can be quickly but securely strapped to the sled, and three or more infants can be strapped down in accommodating basins (or pockets, wells, trays, or similar terms) on the upper surface of the insert. The sled can be lifted and carried, when appropriate, by two or more people, or it can be dragged across any surface (up to and including a set of steps or stairs) by only one adult, if a need arises. Because the insert can be made of a low-density foam rubber or inflatable plastic, it will provide cushioning as well as thermal insulation, and can provide bedding for several infants if a need arises, for as long as the need persists. If desired, one or more “pockets” (or wells, basins, etc.) can be provided in the insert, to carry and hold various types of equipment, such as medical supplies, pharmaceuticals, special nutrients, or equipment that may be needed by one or more of the infants being held by the carrier device.

### BRIEF DESCRIPTION OF THE DRAWINGS

FIG. 1 is a perspective view of an infant carrier device made of lightweight foam rubber, for use with an emergency evacuation sled.

FIG. 2 is a perspective view of the infant carrier device, affixed to a lightweight sled and showing the position of an infant secured to the sled.

### DETAILED DESCRIPTION

As briefly summarized above, this invention comprises an “infant carrier” that is designed to be temporarily affixed, if a need arises, to an “emergency transport apparatus”, such as a lightweight sled of the type sold under the trademark MEDSLED by ARC Products. That type of lightweight sled offers one example of an emergency transport apparatus; however, the infant carrier devices disclosed and illustrated herein can be purchased and stored independently, without requiring such a sled, and if an emergency arises, the carrier device can be affixed (such as by straps, ropes, clamps, etc.) to any type of cart, wagon, gurney, backboard, door, sheet of plywood, or other device that can be rolled, dragged, carried, or otherwise transported by human (muscle) power without requiring gasoline, electricity, or any other type of power that may not be readily available in an emergency.

Such transport, using human muscle power only, is referred to herein as “non-powered” transport. Obviously, the carriers described herein also can be loaded into a car, van, truck or other type of “powered” transport, if desired and if such transport is available. However, when planning ahead for emergency preparedness, it is crucially important to ensure that adequate steps can be taken to transport infants away from immediate danger, even if “powered” transport is unavailable.

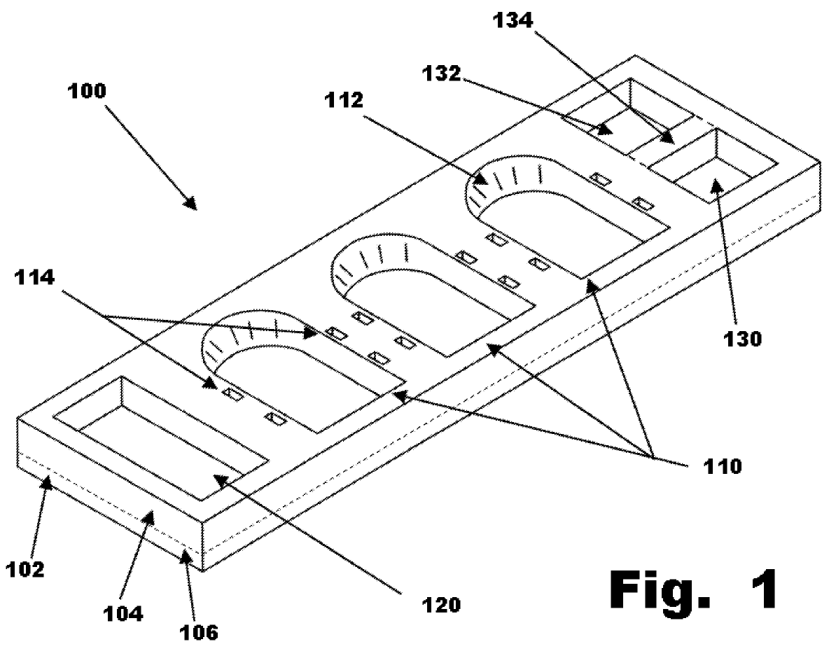

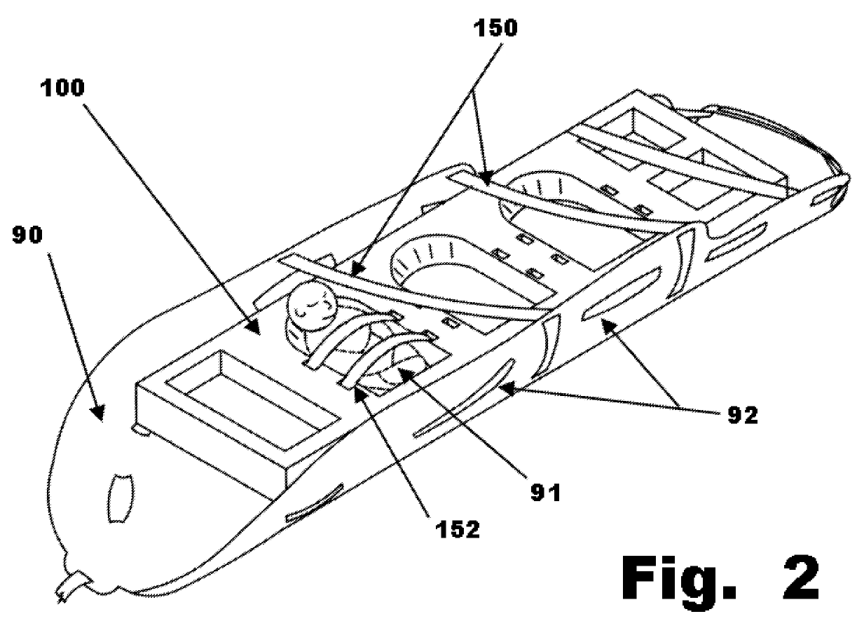

Accordingly, FIGS. 1 and 2 provide perspective views of an infant carrier 100, shown by itself in FIG. 1, and shown strapped to a lightweight flexible sled 90 in FIG. 2.

In the preferred embodiment shown in FIGS. 1 and 2, carrier 100 has three “basins” 110, with each basin designed and sized to hold a single infant, as indicated by the baby 92 in FIG. 2. Basins 110 can also be referred to by any other suitable term, such as wells, trays, beds, holders, baby holders, cradles, bassinets, or similar terms. The rounded side walls 112 of basins 110 are sloped as indicated, for two reasons: (i) the sloping surfaces can serve as pillow-type supports for the heads of any infants; and, (ii) the sloping surfaces also provide a good means of support and transport for extremely small infants, such as premature babies. By contrast, the “foot wall” of each basin 110 preferably should be vertical, and not sloped.

FIG. 1 illustrates a single large “pocket” 120 near one end of carrier 100, and two smaller pockets 130 and 132 near the other end of carrier 100. Pockets 120, 130, and 132 can be called insets, trays, wells, or similar terms, and are designed to hold medical supplies, pharmaceuticals, special nutrients, or equipment that may be needed by one or more of the infants in a carrier, and preferably should have vertical walls. If desired, a larger pocket 120 can be sized and designed to hold an additional infant if a need arises, and any “divider” 134 which separates two smaller pockets 130 and 132 can be designed to be removable, to convert two small pockets into a single large pocket that can accommodate another neonate if needed.

The dimensions of a carrier, and the number of “basins” and “pockets” in any particular carrier, can be altered and adjusted, if desired. For example, carrier with a preferred and suitable size, for use with a MEDSLED sold by ARC Products, is 74 inches long, 22 inches, and 5 inches thick, with three baby basins, each one 18 inches “tall” (or long) by 12 inches wide, separated from each other by 6 inches of flat foam on the upper surface of the carrier. If desired, and if various distances and spacing are adjusted, a fourth baby basin can be “squeezed in”, while still retaining the ability of the two sets of “pockets” at the ends of the carrier to be adapted to also hold infants. This would enable as many as six infants to be carried and held by such a carrier.

In a completed infant carrier, at least one and preferably two pairs of strap slots 114 are positioned on each side of each basin 110. Each pair of matched slots will accommodate a single strap 152, as shown in FIG. 2; accordingly, if two pairs of properly-spaced strap slots 114 are provided around each basin, a first strap can be placed over an infant's chest region, and a second strap can be placed over an infant's legs, as illustrated in FIG. 2.

Strap slots 114 do not need to have a rectangular cross-section, or substantial “thickness” for the opening. Instead, a single cut (created by a long-bladed knife) that passes through the entire thickness of the carrier will help grip, stabilize, and secure any strap or belt that is pushed through the slot, especially if the cut surface of the foam rubber has a rough texture, rather than a smooth and slick surface.

Since strap slots 114 can be made quickly and easily, by means of a single knife cut for each slot, some of the claims below do not specify or require any strap slots. This is intended to remove the temptation for competitors and infringers to sell an infant carrier having no strap slots, but with a set of simple instructions enclosed for how to create such slots, by using a simple knife cut for each slot. Similarly, if a claim specifies that a basin should be “provided with means for securing an infant within said basin”, that particular limit can be satisfied by any suitable means, including but not limited to:

(i) straps which are included with a carrier, and which if desired may be already “threaded” through strap slots or similar affixing means, when an infant carrier is purchased;

(ii) strap slots that are properly positioned for securing infants to the carrier (such as slots that are positioned on opposing sides of each basin);

(iii) the provision of exposed and accessible penetrable surfaces that flank a basin, if the carrier is made of foam rubber or a similar non-inflatable material that can be penetrated by a knife (thereby creating a strap slot or similar orifice) without damaging the carrier device;

(iv) a plurality of hooks, eyelets, or other attachment components that are glued to, molded into, or otherwise affixed to one or more surfaces of an inflatable carrier device, at locations that will enable straps or other securing means to be coupled to said attachment components, in a manner and with a positioning that can be used to secure an infant within each infant-holding basin.

Similarly, some of the claims below do not require any straps to be coupled to or included with an infant carrier. Otherwise, if all claims were to require straps as a part of a claimed carrier device, competitors and infringers could sell a carrier device having no straps, while also selling “strap kits” as a supposedly separate item. Clearly, the use of straps (or similar or substitute components), to hold and secure infants safely and securely in an infant carrier as described herein, is strongly preferable.

In one preferred embodiment, infant carrier 100 can be made conveniently from two layers 102 and 104 of a lightweight and flexible open-cell foam rubber. Each of the basins 110 and pockets 132 and 134 can be cut through the entire upper foam layer 104, and the upper foam layer 104 can then be glued to lower foam layer 102 (which has no holes or cuts, at that stage of assembly), using a thin layer 106 of a suitable chemical adhesive, applied to the bottom surface of the top layer 104. After that gluing operation has been completed, all of the strap slots 114 can be created by a knife cut or similar means, which will automatically ensure that strap slots 114 will be properly aligned and will pass through both layers.

In an alternate preferred embodiment that will enable long-term storage using minimal space and volume, infant carrier 100 can be an inflatable device, made from inexpensive plastic comparable to the plastic used to make pool toys. If desired, an inflation device that holds compressed air or another gas (or that is driven by a battery system) can accompany an uninflated carrier, to ensure that the carrier can be inflated within a few seconds if an emergency arises, even if no electric power is available. These types of inflatable devices can be provided with tension-bearing internal straps or other constraining components, to ensure that a desired and proper shape is created when a carrier is inflated; such internal components are commonly used in numerous types of non-spherical inflatable devices, such as air mattresses. If desired, a non-smooth or otherwise “tacky” surface can be placed on the bottom of an inflatable carrier, to minimize any risk of sliding or other relative motion, while the infant carrier is being carried by a sled or other transport system.

As described in patent application Ser. No. 11/123,568, cited above, the lightweight sled 90 which will support and hold infant carrier 100 preferably should be provided with a flexible strap 92, which generally should extend around all or most of the periphery of sled 90. This is accomplished by passing sled strap 92 through a series of accommodating slots that have been cut, punched, or otherwise passed through the thickness of the plastic sled material, effectively “weaving” the strap into the sled in a manner that creates a set of relatively short strap segments on both the top and bottom surfaces (of the inside and outside surfaces) of the sled. When emplaced in that manner, segments of sled strap 92, on the either side of the sled, can be gripped and used as lifting handles, by people standing or walking on both sides of the sled.

That arrangement also enables sled strap 92 to be used as a reinforced towing and/or dragging attachment means. A single rope or strap can be securely tied to sled strap 92, near either end of sled 90. If a large pulling force is exerted on that tow rope or strap, the tensile forces will be distributed around the entire periphery of sled 90, in a way that will minimize any potential tearing forces that might otherwise damage the plastic sheet of sled 90.

Accordingly, a set of straps 150, as shown in FIG. 2, can be used to secure infant carrier 100 to lightweight sled 90, using any available slots and/or accessible strap segments on the sled, as spaced attachment points. That act of securing the carrier to the sled will effectively cause the side walls of sled 90 to bend and curl upward and inward, thereby effectively creating a large outer shell having the general shape of a shallow basin, with the foam carrier resting securely in and on that shell-type component. In addition, preferred types of open-cell foam rubber generally will create rough and tacky rather than smooth and slick surfaces, which will help minimize any undesired sliding of an infant carrier on a supporting sled.

Furthermore, use of either a lightweight foam or an inflatable plastic device, to make an infant carrier as described herein, will provide both (i) good thermal insulation, and (ii) a form of cushioning. Accordingly, these carriers can provide useful sleeping accommodations for infants, in case a need arises.

Thus, there has been shown and described a new and useful device for enabling emergency transport of multiple infants, with accompanying equipment or supplies. Although this invention has been exemplified for purposes of illustration and description by reference to certain specific embodiments, it will be apparent to those skilled in the art that various modifications, alterations, and equivalents of the illustrated examples are possible. Any such changes which derive directly from the teachings herein, and which do not depart from the spirit and scope of the invention, are deemed to be covered by this invention.

1. An infant carrier device for enabling safe and secure non-powered transport of a plurality of infants, comprising a flexible device that provides, on an upper surface, at least three basins that are sized and suited for placement of an infant in each basin, and wherein said infant carrier device is designed and sized to enable it to be secured to a non-powered transport device designed for carrying a human adult.

2. The infant carrier device of claim 1, wherein said device is designed and sized to enable it to be secured to a lightweight sled made of a flexible plastic material that can be rolled into a cylinder for storage.

3. The infant carrier device of claim 1, wherein each basin is provided with means for securing an infant within said basin.

4. The infant carrier device of claim 3, wherein each basin is flanked by at least one pair of slots, and wherein each slot passed entirely through said infant carrier device in a manner that allows a securing strap to be threaded through each such slot, wherein a single securing strap can be passed through said pair of slots.

5. The infant carrier device of claim 1, wherein said upper surface of said infant carrier device is provided with at least one recessed area that is designed to hold nonliving equipment or supplies.

6. The infant carrier device of claim 1, wherein at least one recessed area is designed to hold nonliving equipment or supplies, and can also be adapted to hold an infant when appropriate.

7. The infant carrier device of claim 1, wherein said device is fabricated from foam rubber.

8. The infant carrier device of claim 1, wherein said device is inflatable.

9. An infant carrier device for enabling safe and secure non-powered transport of a plurality of infants, comprising a flexible device that provides, on an upper surface, a plurality of basins that are sized and suited for placement of an infant in each basin, and that also provides means for securing each infant to the infant carrier device.

10. The infant carrier device of claim 9, wherein said device is designed and sized to enable it to be secured to a sled which is made of a flexible material and which is large enough to transport an adult.

11. The infant carrier device of claim 9, wherein each basin is flanked by at least one pair of slots, and wherein each slot passed entirely through said infant carrier device in a manner that allows a securing strap to be threaded through each such slot, wherein a single securing strap can be passed through said pair of slots.

12. The infant carrier device of claim 9, wherein said upper surface of said infant carrier device is provided with at least one recessed area that is designed to hold nonliving equipment or supplies.

13. The infant carrier device of claim 9, wherein at least one recessed area is designed to hold nonliving equipment or supplies, and can also be adapted to hold an infant when appropriate.

14. The infant carrier device of claim 9, wherein said device is fabricated from foam rubber.

15. The infant carrier device of claim 9, wherein said device is inflatable.
